(19) United States
(12) Patent Application Publication
(10) Pub. No.: US 2016/0206141 A1
(43) Pub. Date: Jul. 21, 2016

(54) Apparatus for Oven Roasting Meat or Meat Product

(71) Applicant: Anthony A. Aquilante, Phoenixville, PA (US)

(72) Inventor: Anthony A. Aquilante, Phoenixville, PA (US)

(21) Appl. No.: 14/965,423

(22) Filed: Dec. 10, 2015

Related U.S. Application Data
(60) Provisional application No. 62/090,876, filed on Dec. 11, 2014.

(51) Int. Cl. A47J 37/06

(52) U.S. Cl. CPC A47J 37/0694

(57) ABSTRACT

The inventor has invented an apparatus designed to effectively and evenly roast meat or meat product, including but not limited to, beef, lamb, chicken and turkey. The system is designed to take a cut of meat or meat product, from the freezer to the serving plate with minimal hands-on preparation. With the apparatus, the meat or meat product is effectively thawed, cooked and served in one container. The apparatus is comprised of an engineered and machined non-stick metal platform with handles, a roasting pan and roasting bag. The impetus for this novel device is single apparatus that gives the user the ability to take the food item from pre-cook preparation to cooking to service with minimal intervention.

### RELATED APPLICATIONS

This application claims the benefit of U.S. Provisional Application No. 62/090,876.

### BACKGROUND OF THE INVENTION

1. Field of the Invention

The invention relates to cooking devices, in particular, an apparatus to aid in the oven roasting of a meat or meat product.

2. Description of Related Art

There has long been a necessity for a cooking device that creates the perfect cooking conditions for poultry. Many prior art devices fail to facilitate these conditions. None encompasses all features to facilitate the ideal conditions for cooking and serving a meat or meat product such as: a non-stick surface for easy sliding onto a serving platter, ideal shape for meat product for even heating as well as stability on rack, solid metal construction for transportation stability, metal handles for lifting the meat or meat product, curved handles for easy lifting, deep raised channels for diverting drippings during the cooking process as well as keeping the meat or meat product separated from the drippings and metallic construction for even heat transfer. In addition to the unique features described above, a roasting pan and roasting bag provide integral functionality such as even heat distribution and moisture retention.

The prior art and differences from the present invention can be summarized as follows:

U.S. Pat. No. 5,638,742 describes a poultry support rack. This device is inherently not solidly constructed and provides little or no support as the product shrinks or changes shape during cooking.

U.S. Pat. No. 4,677,906 describes a pan insert. This device does not provide the structure to lift the product off of the surface of the roasting pan, thereby not separating the fat from the product during cooking.

U.S. Pat. No. 4,334,463 describes a food cooking and lifting device. This device does not provide a stable method for lifting the food out of the device.

U.S. Pat. No. 3,084,617 describes collapsible roasting rack. The device is inherently not stable and meat product will stick to the rack due to the grid design.

U.S. Pat. No. 5,503,062 describes a wire support and inner rack for thin aluminum roasting pan. The device is made of wire framework and meat product will stick to the rack due to the grid design.

### SUMMARY OF THE INVENTION

This invention is a device for efficiently cooking a cut of meat or whole poultry product in an oven or other heat source. The apparatus is designed to go from thaw to cook to serve with minimal intervention. The invention is comprised of an engineered non-stick metal platform tray with handles, a roasting pan and roasting bag. The apparatus has been engineered and refined to allow the ideal transfer of heat to said meat or meat product throughout the cooking process. The shape of the metal platform tray has been designed to serve as a solid platform for staging such poultry as chicken and turkey. The tray has many distinct advantages for cooking purposes including: a non-stick surface for easy sliding onto a serving platter, solid metal construction for transportation stability, metal handles for lifting the meat or meat product, deep raised channels for diverting drippings during the cooking process as well as keeping the meat or meat product separated from the drippings and metallic construction for even heat transfer. The apparatus is further comprised of a roasting pan to catch drippings during the cooking process and a roasting bag to aid in even heat distribution. The roasting pan not only catches drippings and provides added stability to the structure, but also provides a vehicle for introducing gravy mix for instantaneous preparation of gravy with the drippings of the completed meat product. The seasoning and/or gravy mix may be introduced into the pan during the pre-preparation by the manufacturer. The roasting bag surrounds the said parts of the apparatus and provides such functionality as: even cooking, moisture seal and a self-basting mechanism.

### BRIEF DESCRIPTION OF THE DRAWINGS

FIG. 1 shows a view above and diagonal to said rack highlighting distinct characteristics of the device.

FIG. 2 shows a view directly above said rack highlighting distinct characteristics of the device.

FIG. 3 shows an angled view of the front of said rack highlighting distinct characteristics of the device.

FIG. 4 shows a whole bird (meat or meat product) inside said rack housed inside a roasting pan.

FIG. 5 shows a whole bird (meat or meat product) inside the metal platform tray housed inside the roasting pan surrounded by a roasting bag.

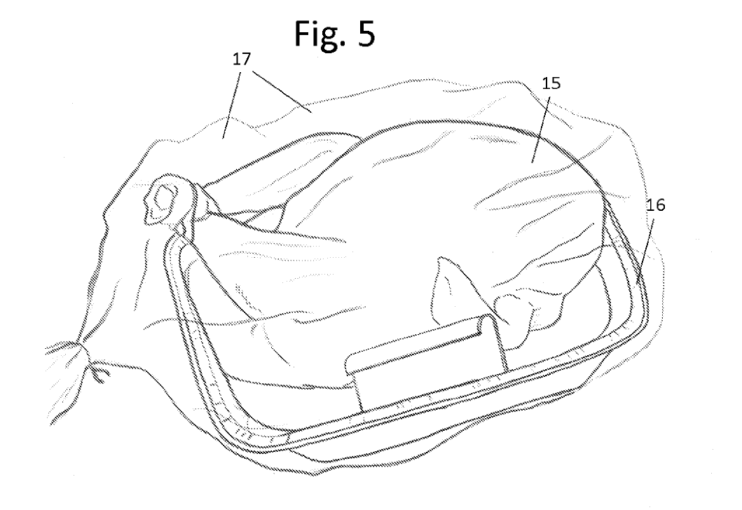

### LIST OF NUMBERS ASSOCIATED WITH ITEMS SHOWN IN THE DRAWINGS

11 channel for rendered fat

12 handle

13 curved end for lifting

14 solid base

15 meat or meat product (poultry)

16 roasting pan

17 roasting bag

### DESCRIPTION OF THE PREFERRED EMBODIMENT

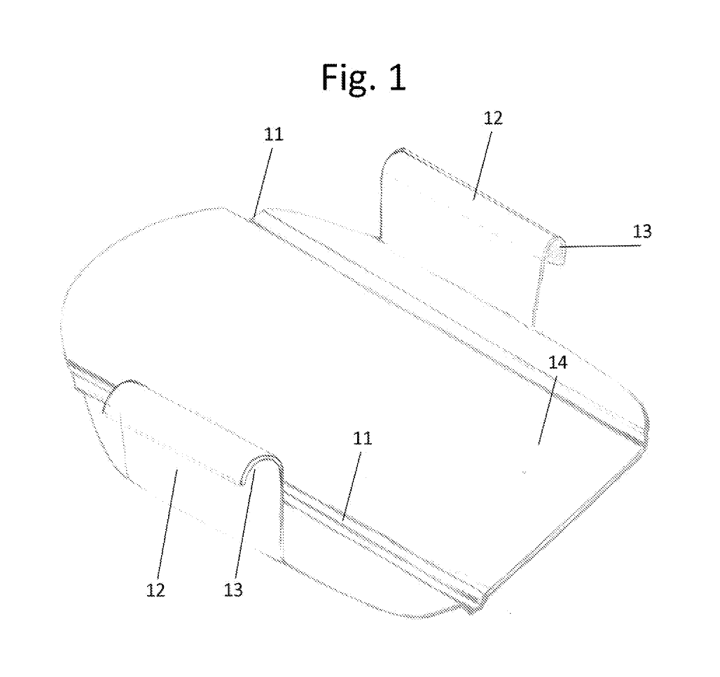

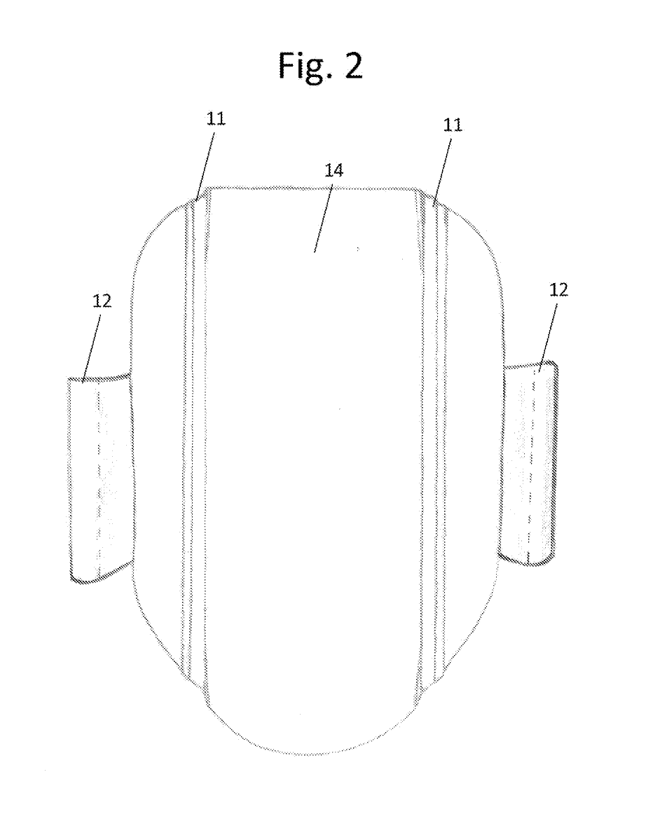

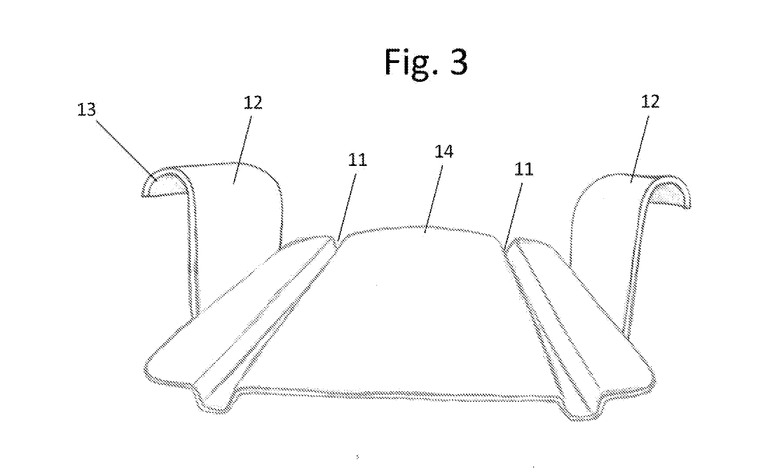

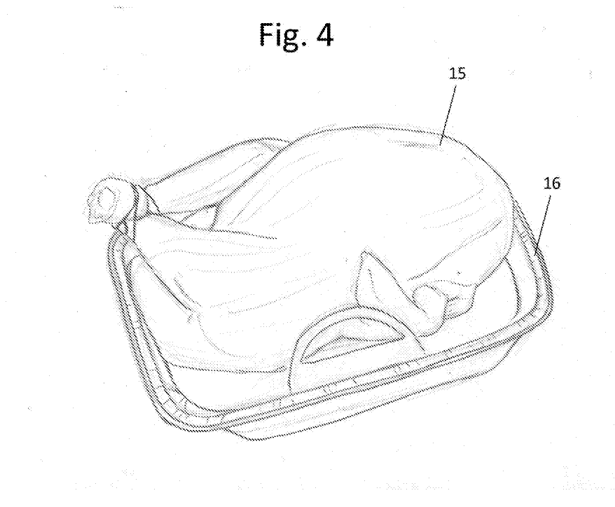

The invention is designed to cook a meat or meat product evenly and thoroughly in an oven or other heat source. See FIGS. 1-4. The rack contains many advantageous features that separates the design from prior art.

The rack provides the user ergonomically engineered handles for ease in handling the rack with the cooked meat or meat product. The rack also contains raised channels to separate the drippings from the cooking bird to eliminate a “soupy” cooked product. The metallic construction provides stability for the user. Additionally, the “open” design ensures even cooking.

Furthermore, the no-stick surface provides ease when transferring the cooked meat from the rack to the table. After the cooking process has completed, the user is able to handle cooked and prepared food product without the need of reaching under a pot or pan by using said handles on the metal platform tray. The user then takes advantage of the non-stick surface and is able to lift the meat or meat product and slide onto the serving or carving plate. No additional devices are required for the transfer.

Finally, the user is able to use a whisk and mix the drippings with the added seasonings and/or gravy mix in the pan located on the outside of the rack. This eliminates the need for an independent container for gravy preparation.

The preferred embodiment is comprised of a metal rack with a solid metal base 14 that provides a stable platform for the meat or meat product. Said metal rack is further comprised of two channels 11 that serve multiple functions: channel the rendered fat away from the meat product during cooking, raise meat away from the pool of rendered fat and provide a break from the base surface for easier movement (sliding) from the rack onto a preparatory platform. Said rack is further comprised of a set of handles 12 on either side of the base to support the weight of the meat or meat product. Said handles include curved ends 13 for lifting the rack and product from the oven roasting pan. Said curved ends provide stability when lifting said rack and meat product. Said rack is comprised of metal unibody construction throughout all features (11, 12, 13 and 14) to provide stability, durability and ease of use.

In addition, the apparatus includes a roasting pan 16 that further secures the meat or meat product 15 and provides an additional stable base. Concurrently, said roasting pan 15 provides a reservoir for meat dripping and rendered fat to be used in gravy construction. The roasting bag 17 further ensures proper moisture during cooking and even heating.

What is claimed is:

1. A rack for oven roasting meat or meat product comprising:
a metal unibody base;
said base comprised of a non-stick surface;
said base connected to two (2) deep well channels;
said base and channels in a specific shape to accommodate meat or meat product;
said base connected to two (2) handles;
said handles connect to curved ends.

2. The apparatus of claim 1, wherein said rack comprises:
said base integrated with three (3) deep well channels.

3. The apparatus in claim 1, 2, 3, 4 or 5, wherein said apparatus is housed in a roasting pan.

4. The apparatus in claim 6, wherein said apparatus is housed in a roasting bag.
